(19) United States
(12) Patent Application Publication
(10) Pub. No.: US 2019/0128718 A1
(43) Pub. Date: May 2, 2019

(54) INCREASING ACCURACY OF PARTICLE IMAGE VELOCIMETRY VIA GRAPHENE OR GRAPHITE FLAKES

(71) Applicant: Siemens Energy, Inc., Orlando, FL (US)

(72) Inventor: Joshua S. McConkey, Orlando, FL (US)

(21) Appl. No.: 15/795,358

(22) Filed: Oct. 27, 2017

(51) Int. Cl. G01F 1/74; G01M 15/14

(52) U.S. Cl. CPC G01F 1/74; G01M 15/14

(57) ABSTRACT

A method and system to accurately characterize the velocity of a fluid flow through a flow channel using particle image velocimetry is provided. The method includes introducing a plurality of seeding particles to the fluid flow. The seeding particles are essentially two dimensional such that each particles length and width are much greater than its thickness. At least two closely spaced pluses of light are repetitively delivered to the fluid flow, each pulse of light illuminating a successive planar cross section of the fluid flow in a flow direction. Images of each illuminated cross section are captured using an image receiver. A processor receives the images from the image receiver and analyzes the captured images in order to characterize the velocity of the fluid flow.

### BACKGROUND

### 1. Field

The present disclosure relates generally to methods to assess characteristics of fluid flow, and more particularly, to a method to characterize the velocity of a fluid flow through a flow channel.

### 2. Description of the Related Art

Particle image velocimetry (PIV) is an optical method of flow visualization used to assess the characteristics of fluid flow. Seeding particles, for example, small droplets of oil or water, are introduced into the flow stream under study. A laser sheet is then shone into the flow field. As the seeding particles subtend the laser sheet, they are illuminated, but only while in the thin laser sheet. Digital cameras may be used to capture images of a sequence of light pulses. A processor is then used to measure and count the seeding particles within the captured images. From these images, the local instantaneous velocity at that part of the flow may be measured based on the movement of the particles through the separate image frames.

There are disadvantages using particle image velocimetry, however. Because the droplets or spherical particles do not have a perfect drag coefficient, the velocity of the particles is not necessarily the velocity of the fluid being measured. This is especially true in dynamic, somewhat turbulent, or accelerating flows, such as those found throughout a gas turbine. Further, higher visibility of seeding particles is desirable for ease of measurement. However, as the seeding particle masses increase, their drag becomes less and less ideal. So, with increasing visibility/mass the seeding particles' speed becomes a worse representation of the fluid flow velocity. Additionally, the surface area of the seeding particle (which controls the reflected brightness) only increases with the square root of the mass. So, in order to get twice the brightness, the mass must increase by a factor of four.

Consequently, an improvement to the method of particle image velocimetry in order to increase the accuracy of measuring the instantaneous velocity of a fluid flow is desired.

### SUMMARY

Briefly described, aspects of the present disclosure relates to a method to accurately characterize the velocity of a fluid flow through a flow channel using particle image velocimetry and a system for characterizing the velocity of a fluid flow using particle image velocimetry through a flow channel.

A method to accurately characterize the velocity of a fluid flow through a flow channel using particle image velocimetry is provided. The method includes the steps of introducing a plurality of seeding particles to the fluid flow and then repetitively delivering at least two closely spaced pulses of light in order to track the motion of the seeding particles. The plurality of seeding particles are essentially two-dimensional such that each particle's length and width are greater than its thickness. Each pulse of light illuminates a successive planar cross section of the fluid flow in a flow direction. An image of each illuminated planar cross section of the fluid flow can be captured by an image receiver. From the captured images, the velocity of the fluid flow through the flow channel may be determined.

A system to characterize the velocity of a fluid flow using particle image velocimetry through a flow channel is also provided. The system includes a flow channel through which a fluid flows, the fluid comprising a plurality of fluid particles and a plurality of seeding particles. The plurality of seeding particles are essentially two-dimensional such that each particle's length and width are greater than its thickness. A light source is provided to supply optical radiation in the form of a laser sheet to illuminate a cross section of the fluid flow. An image receiver may be used for capturing an image(s) of the illuminated cross section(s). The image receiver sends the image(s) to a processor communicatively coupled to the image receiver which receiver the image(s). The processor is effective to analyze the captured image(s) in order to characterize the velocity of the fluid flow.

### BRIEF DESCRIPTION OF THE DRAWING

FIG. 1 illustrates a schematic view of a system for characterizing the velocity of a fluid flow using particle image velocimetry through a flow channel.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

The application proposes utilizing seeding particles, each with an essentially two dimensional structure, in the fluid flow. More particularly, the seeding particles may comprise graphite or graphene flakes.

Graphite (or graphene, a single one atom thick layer of graphite) flakes have a stronger interaction (higher drag coefficient) than spherical particles which are typically used in PIV. The drag coefficient of an object describes its resistance in a fluid. For example, the factor k is the shape-determined part of calculating the drag coefficient of different shapes. A sphere, has a k factor of approximately 0.5, giving a sphere a relatively high drag coefficient. Graphene flakes have a k factor of approximately 0.02 so that graphene (and the thicker, layered version graphite) has lower drag coefficient leading to higher drag. The lower drag coefficient of graphene and graphite leads to a much closer match between the seeding particles and the fluid particles. Additionally, graphite particles may be illuminated by a light source such that their surfaces are at least partially reflective making them a good particle for PIV.

In a turbomachine, such as a gas turbine engine, air is pressurized in a compressor section then mixed with fuel and burned in a combustion section to generate hot combustion gases. The hot combustion gases are expanded within a turbine section of the engine where energy is extracted from the combustion gases to power the compressor section to produce useful work, such as turning a generator to produce electricity. Particle flow velocimetry may be used, for example, to measure fluid flows within the gas turbine engine such as the combustion gas flow at the outlet of the combustor or the air flow at the inlet of the compressor.

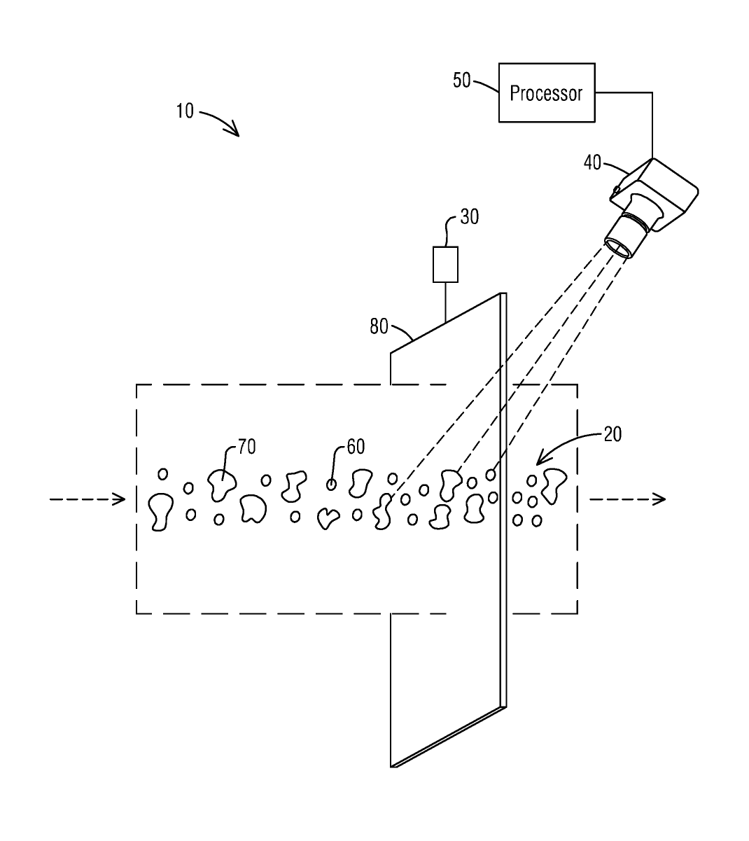

Embodiments will be described below with reference to the Figure. FIG. 1 is a schematic view of a system 10 for characterizing the velocity of a fluid flow through a flow channel 20 utilizing particle image velocimetry according to an embodiment. The system 10 includes a flow channel 20 through which a fluid flows in a flow direction (as shown by the arrows). The system 10 further includes a light source 30 supplying optical radiation in the form of a laser sheet 80 which will subtend the flow stream and illuminate a cross section of the fluid flow. An image receiver 40 is provided to capture images of the illuminated cross section. The image receiver 40 is communicatively coupled to a processor 50 which receives the images for storage and/or analysis.

The fluid flowing within the flow channel 20 may comprise fluid particles 60 whose velocity is to be assessed and a plurality of seeding particles 70. The seeding particles 70 each include an essentially two dimensional shape such that the length and width dimension are greater, such as orders of magnitude greater, than the thickness dimension. For example, in an embodiment, the thickness may be less than 1/10 of the length and width dimensions. In a more preferred embodiment, the thickness is less than 1/100 of the length and width dimensions, and in a most preferred embodiment, the thickness is less than 1/1,000,000 of the length and width dimensions. When the seeding particles 70 are illuminated by the laser sheet 80, they facilitate reflection of the light which may then be captured by the image receiver 40. The fluid particles 60 may comprise air, combustion gas, and/or liquids. In an embodiment, the seeding particles 70 comprise graphite or graphene particles as described above. While the seeding particles 70 described in this disclosure are graphite or graphene particles, other two dimensional particles may be used as well.

A further example may be two dimensional alumina flakes. Alumina flakes are highly reflective making them a good choice as seeding particles for particle image velocimetry.

The illustrated system 10 includes a light source such as a laser source 30. The laser source may be a pulsed laser or a continuous laser. In an embodiment, the pulsed or continuous laser is effective to irradiate a planar cross section of the fluid flow.

Referring to the FIG. 1, a method to accurately characterize the velocity of a fluid flow through a flow channel 20 using particle image velocimetry is also provided. The method to characterize the velocity of a fluid flow through a flow channel 20 may include the steps of introducing a plurality of seeding particles 70 to the fluid flow. In order to more accurately measure the velocity of the fluid flow, the seeding particles 70 may include a high drag coefficient and a low mass. Particles that are essentially two dimensional typically have high drag coefficients and low mass, making them more ideal for accurately measuring the velocity of a fluid flow. For example, the fluid flow to be measured may be appropriately selected from fluids such as those described above and the seeding particles 70 may be essentially two dimensional particles such as graphite.

A light source 30, such as a pulsed or continuous laser, may be used to irradiate the fluid flow so that a laser sheet 80 subtends a cross section of the fluid flow. The pulsed laser 30 may be utilized to repetitively deliver at least two closely spaced pulses of light to two successive, in a flow direction, planar cross sections of the fluid flow resulting in the two successive planar cross sections being illuminated.

In a capturing step, an image receiver 40 is used to photograph the laser sheet 80. The image receiver 40 can capture images of the illuminated seeding particles 70 within each laser sheet 80. Utilizing the processor 50, the image data may be used to determine the velocity of each seeding particles 70. Having data from at least two different cross sections, in a flow direction, of the fluid flow is adequate to calculate the fluid velocity using known methods. Including more than two captured images from successive illuminated planar cross sections may increase the accuracy of the velocity measurement even further.

Advantages in utilizing two dimensional particles compared with conventionally used spherical particles include a more accurate fluid flow velocity measurement. The higher drag coefficient of graphite flakes leads to a much closer match between particle and flow velocities. Two dimensional particles may have the advantage of having a larger surface area with a smaller mass with the result that the particles are more visible when the light is reflected off the surface. For example, graphene flakes (as well as the thinker graphite flakes) have a high ratio of area to thickness. A graphene flake only 10 atoms thick can be many mm in diameter. Additionally, graphene/graphite flakes are inexpensive, fairly inert, and have good strength. Thus, by utilizing graphene/graphite flakes as the seeding particles, the error in velocity may be reduced from 1-2% down to 0.2-0.3%.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A method to accurately characterize the velocity of a fluid flow through a flow channel 20 using particle image velocimetry, comprising:
introducing a plurality of seeding particles 70 to the fluid flow;
repetitively delivering at least two closely spaced pulses of light in order to track the motion of the seeding particles 70 wherein each pulse of light illuminates a successive planar cross section of the fluid flow in a flow direction;
capturing an image of each illuminated planar cross section of the fluid flow; and
determining the velocity of the fluid flow through the flow channel using the captured images,
wherein the plurality of seeding particles 70 are essentially two dimensional.

2. The method as claimed in claim 1, wherein the plurality of seeding particles 70 are graphite or graphene flakes.

3. The method as claimed in claim 1, wherein the thickness dimension of each of the plurality of seeding particles is less than 1/10 of its length and width dimensions.

4. The method as claimed in claim 3, wherein the thickness dimension of each of the seeding particles is less than 1/100 of its length and width dimensions.

5. The method as claimed in claim 4, wherein the thickness dimension of each of the seeding particles is less than 1/1000000 of its length and width dimensions.

6. The method as claimed in claim 1, wherein the plurality of seeding particles 70 are alumina flakes.

7. The method as claimed in claim 1, wherein the fluid flow is a flow of air in a gas turbine engine.

8. The method as claimed in claim 1, wherein the fluid flow is a flow of combustion gas in a gas turbine engine.

9. A system 10 for characterizing the velocity of a fluid flow using particle image velocimetry through a flow channel 20, comprising:
a flow channel 20 through which a fluid flows, the fluid comprising a plurality of fluid particles 60 and a plurality of seeding particles 70;
a light source 30 supplying optical radiation in the form of a laser sheet 80 to illuminate a cross section of the fluid flow;
an image receiver 40 for capturing an image of the illuminated cross section;
a processor 50 communicatively coupled to the image receiver 40 and adapted to receive and analyze the captured image in order to characterize the velocity of the fluid flow,
wherein the plurality of seeding particles 70 are essentially two dimensional particles.

10. The system as claimed in claim 9, wherein the plurality of seeding particles 70 are graphite or graphene flakes.

11. The system as claimed in claim 9, wherein the plurality of seeding particles 70 are alumina flakes.

12. The system 10 as claimed in claim 9, wherein the thickness dimension of each of the plurality of seeding particles is less than 1/10 of its length and width dimensions.

13. The system 10 as claimed in claim 12, wherein the thickness dimension of each of the seeding particles is less than 1/100 of its length and width dimensions.

14. The system 10 as claimed in claim 13, wherein the thickness dimension of each of the seeding particles is less than 1/1000000 of its length and width dimensions.

15. The system 10 as claimed in claim 9, wherein the fluid flow is a flow of air in a gas turbine engine.

16. The system 10 as claimed in claim 9, wherein the fluid flow is a flow of combustion gas in a gas turbine engine.
